(19) United States
(12) Patent Application Publication
(10) Pub. No.: US 2008/0261609 A1
(43) Pub. Date: Oct. 23, 2008

(54) METHOD OF ALLOCATING RESOURCES IN A RADIO BASE STATION APPARATUS

(76) Inventors: Masao Murai, Tokyo (JP); Kouji Yajima, Tokyo (JP)

Correspondence Address: NEC CORPORATION OF AMERICA, 6535 N. STATE HWY 161, IRVING, TX, 75039, US

(21) Appl. No.: 12/055,129

(22) Filed: Mar. 25, 2008

(30) Foreign Application Priority Data
Mar. 27, 2007 (JP) 2007-081733

(51) Int. Cl. H04Q 7/20

(52) U.S. Cl. 455/452.1

(57) ABSTRACT

A method of allocating resources in a radio base station apparatus is disclosed. A call processing controller, upon receipt of a call connection request from a mobile terminal, multicasts a resource allocation request to each signal processing card in a signal processor. Each signal processing card that has received the resource allocation request, searches resources in the respective card managed by each signal processing card for unused resources and transmits a resource allocation response message to the call processing controller that is indicative of whether the resources can be allocated or not. The call processing controller transmits a resource allocation message to the signal processing card that has transmitted the resource allocation response message which was first received by said call processing controller, and which indicates that the resource can be allocated, and causes the signal processing card to allocate the resources.

The present application is claiming the priority of the earlier Japanese patent application No. 2007-081733 filed on Mar. 27, 2007, the entire disclosure thereof being incorporated herein by reference thereto.

### BACKGROUND OF THE INVENTION

1. Field of the Invention

The present invention relates to a method of allocating resources in a radio base station apparatus.

2. Description of the Related Art

As a method of allocating resources in a radio base station, a method is conventionally adopted wherein a call processing controller performs central management of resources that are owned by all signal processing cards in a signal processor. For example, Japanese Patent No. 2004-32610A describes that a call processing controller performs central management of allocating resources that are owned by CH (channel) cards.

FIG. 1 is a block diagram showing a related base station apparatus. Radio base station apparatus 1′ comprises: transmission channel processor 6 for performing a transmission channel processing between itself and base station controller 2; radio processor 7 for performing radio processing between itself and mobile terminal 3; call processing controller 4′ for controlling call processing; signal processor 5′ for processing signals; and resource managing memory 8 that is a memory for call processing controller 4′ to manage usage of the resources. The signal processor 5′ includes two signal processing cards 51′ and 52′.

FIG. 2 is a sequence chart showing the operation of the radio base station apparatus shown in FIG. 1. Upon receipt of a call connection request from mobile terminal 3, call processing controller 4′ searches all the resources in radio base station apparatus 1′ for unused resources (step 201). FIG. 2 illustrates a case where signal processing card 51′ has unused resources. As shown in FIG. 2, call processing controller 4′ transmits a resource allocation message to signal processing card 51′ for allocating resources (step 202).

With the recent increase in a communication speed and increased capacity of a mobile communication, the number of resources in a signal processor to be mounted in a single radio base station apparatus is also increased, rendering the processing load in the call processing controller higher, and requiring a large capacity of memory. Accordingly, a high-speed CPU and a memory with a larger capacity have to be equipped in the call processing controller. This in turn has caused a problem of heat radiation due to centrally generated heat in the call processor, necessitating the use of high-priced components.

### SUMMARY OF THE INVENTION

It is an object of the present invention is to provide a method of allocating resources and a radio base station apparatus which is inexpensive and easy to design.

The call processing controller, upon receipt of a call connection request from a mobile terminal, multicasts a resource allocation request to each signal processing card in said signal processor. Each signal processing card that has received said resource allocation request, searches resources in the respective card managed by each signal processing card for unused resources and transmits a resource allocation response message to the call processing controller that is indicative of whether the resources can be allocated or not. The call processing controller transmits a resource allocation message to the signal processing card that has transmitted the resource allocation response message which was first received by said call processing controller, and which indicates that the resource can be allocated, and causes the signal processing card to allocate the resources.

By transferring part of resource allocation processing to the signal processor, the present invention achieves distribution of loads on the signal processor while reducing loads on the call processing controller. The distribution of the loads concentrated on the call processing controller thus provides a radio base station apparatus which is inexpensive and easy to design.

### BRIEF DESCRIPTION OF THE DRAWINGS

FIG. 1 is a block diagram of a related radio base station apparatus;

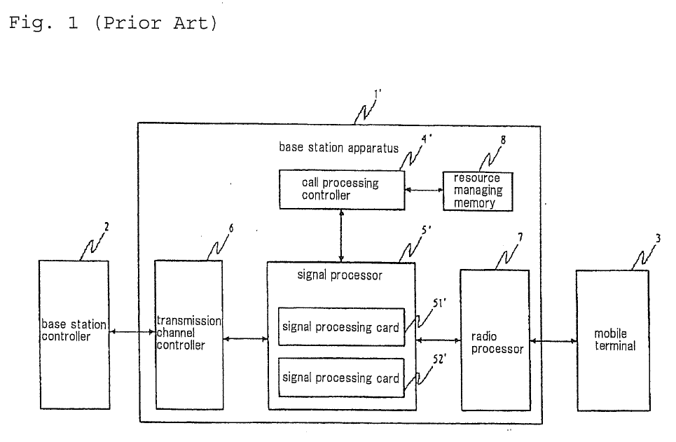

FIG. 2 is a sequence chart showing operation of the radio base station apparatus shown in FIG. 1;

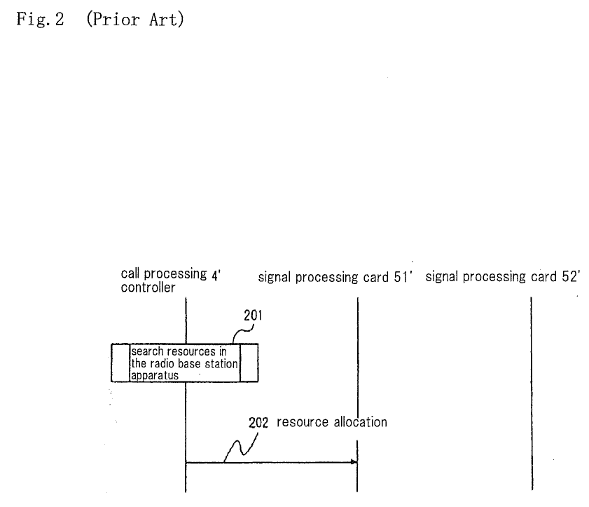

FIG. 3 is a block diagram of a radio base station apparatus according to a first exemplary embodiment of the present invention;

FIG. 4 is a sequence chart showing operation of the radio base station apparatus shown in FIG. 3; and

FIG. 5 is a block diagram of a radio base station apparatus according to a second exemplary embodiment of the present invention.

The above and other objects, features and advantages of the present invention will become apparent from the following description with reference to the accompanying drawings which illustrate examples of the present invention.

### EXEMPLARY EMBODIMENTS

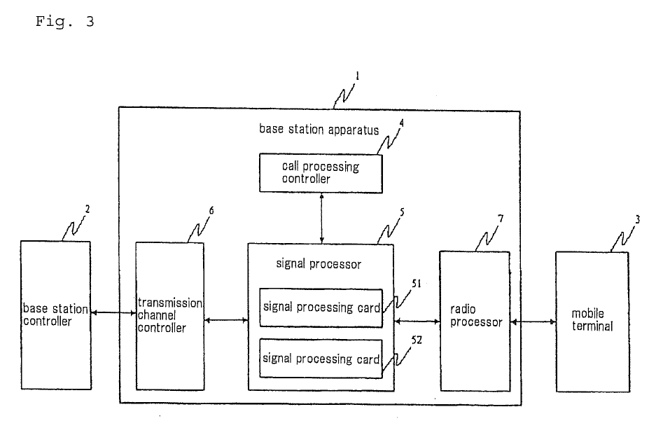

Referring now to FIG. 3, there is shown radio base station apparatus 1 according to a first exemplary embodiment of the present invention which is connected with a network via its upper base station controller 2 and which offers service to mobile terminal 3 over a radio channel. Radio base station apparatus 1 includes call processing controller 4, signal processor 5, transmission channel processor 6, and radio processor 7. In response to a call connection request from mobile terminal 3, call processing controller 4 allocates resources in signal processor 5 to a call. In the exemplary embodiment, signal processor 5 is made up of two signal processing cards 51 and 52. Signal processor 5 decodes a signal received from mobile terminal 3 and encodes a signal to be transmitted to mobile terminal 3. Signal processing cards 51 and 52 each has functions of managing its resources and, in response to a request from call processing controller 4, of replying whether the resources can be allocated or not. Transmission channel processor 6 communicates with base station controller 2 via the ATM (Asynchronous Transfer Mode) or an IP (Internet Protocol) transmission channel. Radio processor 7 communicates with mobile terminal 3 using, for example, a W-CDMA (Wideband Code Division Multiple Access) communication scheme which is standardized in 3GPP.

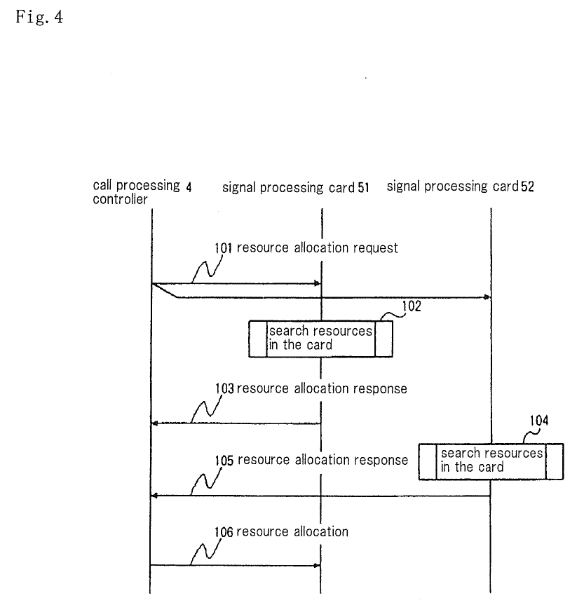

Operation of radio base station apparatus 1 will next be described with reference with the sequence chart shown in FIG. 4.

In the figure, upon receipt of a call connecting request, call processing controller 4 multicasts a resource allocation request message to signal processing cards 51 and 52 (step 101). Each of signal processing cards 51 and 52 that has received the resource allocation request searches itself for unused resources (steps 102 and 104), and transmits a resource allocation response message to call processing controller 4 that is indicative of whether the resources can be allocated or not (step 103 and 105). At this time, by making processing for searching for unused resources in each of signal processing cards 51 and 52 a lower priority than processing for a call that has already been allocated in each of signal processing cards 51 and 52, there arises a difference in a resource allocation response return time that is dependent upon the processing loads. That is, a resource allocation response from a signal processing card with a lighter load is returned first. Call processing controller 4 that has received the resource allocation response transmits a resource allocation message to a signal processing card that has transmitted the resource allocation response indicating that the resources can be allocated, which was first received by call processing controller 4, to cause the signal processing card to allocate the resources (step 106).

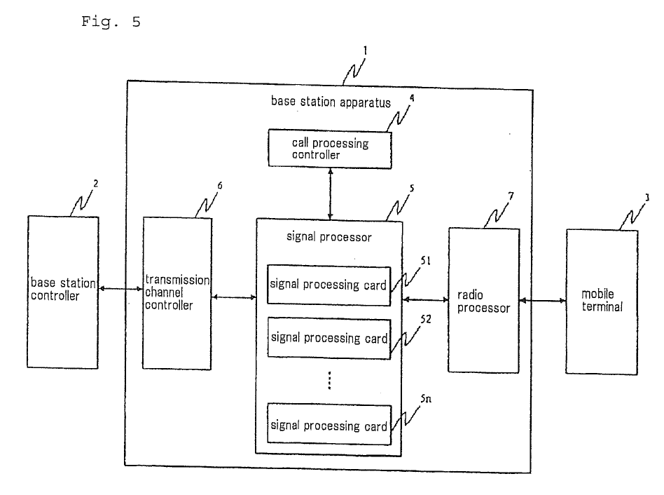

FIG. 5 is a block diagram of a radio base station apparatus according to a second exemplary embodiment of the present invention. In this exemplary embodiment, signal processor 5 is made up of n cards: signal processing cards 51 to 5n. The number of signal processing cards is thus not limited to two. Assuming the number of resources that are owned by the signal processing cards is constant, the larger the number of the signal processing cards becomes, the greater will be the advantages of the present invention.

The above mentioned embodiments provide the following advantages:

First, since the call processing controller has a reduced load and reduced memory capacity, the call processing controller can be fabricated using inexpensive components, and heat can be prevented from being generated in a concentrated manner, thus facilitating a heat radiation design.

Second, since the allocation of resources to signal processing cards is distributed, a reduction in call losses which occur when a signal processing card breaks, is possible.

While preferred embodiments of the present invention have been described using specific terms, such description is for illustrative purposes only, and it is to be understood that changes and variations may be made without departing from the spirit or scope of the following claims.

### INCORPORATION BY REFERENCE

This application is based upon and claims the benefit of priority from Japanese Patent Application No. 2007-081733, filed on Mar. 27, 2007, the disclosure of which is incorporated herein in its entirety by reference.

What is claimed is:

1. A method of allocating resources in a radio base station apparatus, the apparatus comprising a call processing controller for controlling call processing, and a signal processor including a plurality of signal processing cards for processing signals, said method comprising:
at said call processing controller,
upon receipt of a call connection request from a mobile terminal, multicasting a resource allocation request to each signal processing card in said signal processor;
at each signal processing card that has received said resource allocation request searching resources in the respective card managed by each signal processing card for unused resources and transmitting a resource allocation response message to said call processing controller that is indicative of whether the resources can be allocated or not; and
at said call processing controller,
transmitting a resource allocation message to the signal processing card that has transmitted the resource allocation response message which was first received by said call processing controller, and which indicates that the resource can be allocated, and causing the signal processing card to allocate the resources.

2. The method according to claim 1, wherein, in each of the signal processing cards, processing for searching for unused resources has been made a lower priority than processing a call that has already been allocated.

3. A radio base station apparatus comprising:
a call processing controller for controlling call processing; and
a signal processor including a plurality of signal processing cards for processing signals
said call processing controller including means for, upon receipt of a call connection request from a mobile terminal, multicasting a resource allocation request to each signal processing card in said signal processor, and means for transmitting a resource allocation message to the signal processing card that has transmitted the resource allocation response message which was first received by said call processing controller, and which indicates that the resource can be allocated, and causing the signal processing card to allocate the resources;
each signal processing card in said signal processor including means for, upon receipt of said resource allocation request, searching resources in the respective card managed by each signal processing card for unused resources and transmitting a resource allocation response message to said call processing controller that is indicative of whether the resources can be allocated or not.

4. The radio base station apparatus according to claim 3, wherein, in each of the signal processing cards, processing for searching for unused resources has been made a lower priority than processing a call that has already been allocated.
